(19) United States
(12) Patent Application Publication
(10) Pub. No.: US 2025/0077757 A1
(43) Pub. Date: Mar. 6, 2025

(54) LOW-SKEW SOLUTIONS FOR LOCAL CLOCK NETS IN INTEGRATED CIRCUITS

(71) Applicant: Xilinx, Inc., San Jose, CA (US)

(72) Inventor: Satish B. Sivaswamy, Fremont, CA (US)

(73) Assignee: Xilinx, Inc., San Jose, CA (US)

(21) Appl. No.: 18/458,927

(22) Filed: Aug. 30, 2023

(51) Int. Cl. G06F 30/396; G06F 17/12; G06F 30/394

(52) U.S. Cl. CPC G06F 30/396; G06F 17/12; G06F 30/394

(57) ABSTRACT

Generating low skew clock solutions for local clocks in an integrated circuit includes, for a circuit design, determining a plurality of delay ranges for respective clock pins of a local clock net. Each delay range of the plurality of delay ranges includes an upper bound delay and a lower bound delay. The upper bound delays of the plurality of delay ranges are allocated as setup constraints for the respective clock pins of the local clock net. The lower bound delays are allocated as hold constraints for the respective clock pins of the local clock net. The local clock net is routed using the setup constraints and the hold constraints.

### RESERVATION OF RIGHTS IN COPYRIGHTED MATERIAL

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This disclosure relates to integrated circuits (ICs) and, more particularly, to low-skew solutions for local clock nets.

### BACKGROUND

Within integrated circuits (ICs), clock signals are typically conveyed over dedicated clock circuitry, referred to as “clock network circuitry” or as “global clock network circuitry,” in the IC. Clock network circuitry is designed to minimize clock skew. In some cases, clock nets or clock signals—to be distinguished from clock network circuitry, are routed using circuitry other than the clock network circuitry, referred to herein as “non-clock network circuitry.” For example, one or more clock nets of a circuit design may require a level of signal processing that is more complex than can be handled by the clock network circuitry. In applications such as emulation and prototyping, more complex clocking logic may be required so that components such as lookup tables and/or flip-flops are embedded in signal paths used to route the clock nets.

In other examples, using the clock network circuitry may be excessive to route a clock signal that is used only in a localized region of the IC, particularly since the clock network circuitry is often designed to convey signals with low skew over large distances on the IC. The use of clock network circuitry in such an instance when a clock signal need only be conveyed over a short distance may increase the latency of the clock signal owing to the large routing distance introduced by the clock network circuitry to route the clock signal. In other examples, the circuit design may be so large that the clock network circuitry does not have enough resources to handle all of the clock nets of the user's circuit design. In cases such as these and potentially others, clock nets may be conveyed over non-clock network circuitry in the IC.

When clock nets are conveyed over clock network circuitry of an IC, the clock nets have a high degree of skew predictability. Once the clock nets are routed using the clock network circuitry, the impact of the timing of the clock nets on the rest of the data paths of the IC for a given circuit design is known. The implementation tools can proceed with data path optimizations based on this predictability.

The use of non-clock network circuitry to route a clock net and convey clock signals in an IC can be challenging for a number of different reasons. For example, certain resources, such as programmable delays that compensate for delay variation in clock signals, may not be available in non-clock network circuitry. In another example, routing clock nets as part of the same routing process used to route data nets of the circuit design may lead to congestion where clock nets and data nets compete for routing resources during the routing process. Implementation tools also lack timing and/or delay constraints for clock pins. Such constraints are typically available for the data pins but are interpreted or applied with reference to clock pins.

For at least the reasons described above, clock nets routed using non-clock network circuitry often have delays and skews that are unpredictable. This results in an inability of the implementation tools to implement reliably timed data paths and/or to optimize the data paths for the circuit design.

### SUMMARY

In one or more example implementations, a method includes, for a circuit design, determining a plurality of delay ranges for respective clock pins of a local clock net. Each delay range of the plurality of delay ranges includes an upper bound delay and a lower bound delay. The method includes allocating the upper bound delays of the plurality of delay ranges as setup constraints for the respective clock pins of the local clock net. The method includes allocating the lower bound delays of the plurality of delay ranges as hold constraints for the respective clock pins of the local clock net. The method includes routing the local clock net using the setup constraints and the hold constraints.

The foregoing and other implementations can each optionally include one or more of the following features, alone or in combination. Some example implementations include all the following features in combination.

In some aspects, determining the plurality of delay ranges includes creating a linear programming formulation of a delay budget problem for the circuit design. The linear programming formulation includes variables and expressions defining relationships between the variables. A selected expression maximizes the delay range for each clock pin of the local clock net. The method can include solving the linear programming formulation using a linear programming solver.

In some aspects, the method includes computing the lower bound delays of the plurality of delay ranges for the respective clock pins of the local clock net using scaling factors for the upper bound delays.

In some aspects, the plurality of delay ranges are determined for a set of one or more skew values.

In some aspects, the method includes performing a plurality of iterations of the determining the plurality of delay ranges for the respective clock pins of the local clock net, wherein each iteration of the plurality of iterations is for a different set of one or more skews. Accordingly, the allocating the upper bound delays, the allocating the lower bound delays, and the routing are performed for a selected plurality of delay ranges from a selected iteration of the plurality of iterations.

In some aspects, the sets of one or more skews for the plurality of iterations are determined based on a binary search technique.

In some aspects, the method includes clustering the clock pins of the local clock net using a proximity-based clustering technique to generate a plurality of clusters. The method includes, for each cluster, driving each clock pin of the cluster using a same buffer.

In some aspects, the method includes, for a selected cluster of the plurality of clusters having a plurality of sub-clusters therein, implementing a spiral search from a centroid of the plurality of sub-clusters for an unused buffer. The method includes routing a driver of the local clock net to the unused buffer. The method includes routing the unused buffer of the local clock net to the buffer of each cluster.

In one or more example implementations, a system includes one or more hardware processors configured (e.g., programmed) to initiate and/or execute operations as described within this disclosure.

In one or more example implementations, a computer program product includes one or more computer readable storage mediums having program instructions embodied therewith. The program instructions are executable by computer hardware, e.g., a hardware processor, to cause the computer hardware to initiate and/or execute operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 illustrates an example circuit design including a local clock net.

FIG. 2 illustrates an example method of low-skew local clock implementation for a circuit design.

FIG. 3 illustrates an example routing topology for a local clock net.

FIG. 4 illustrates an alternative routing topology for the local clock net of FIG. 3.

FIG. 5 is a table illustrating the skew between different pairs of clock pins of the alternative routing topology of the local clock net shown in FIG. 4.

FIG. 6 illustrates an example of a local clock net in which the system has employed proximity-based clustering during routing.

FIG. 7 illustrates an example method of performing the proximity-based clustering described in connection with FIG. 6.

FIG. 8 illustrates another view of the local clock net of FIG. 6.

FIG. 9 illustrates another example method for implementing local clocks for a circuit design in accordance with the inventive arrangements described within this disclosure.

FIG. 10 illustrates an example implementation of a data processing system for use with the inventive arrangements described within this disclosure.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to integrated circuits (ICs) and, more particularly, to low-skew solutions for circuit designs that utilize local clock nets. In accordance with the inventive arrangements described within this disclosure, methods, systems, and computer program products are disclosed that are capable of optimizing and/or alleviating skew to address timing closure challenges for circuit designs that use local clock nets. The inventive arrangements also improve the predictability of timing for circuit designs that use local clock nets.

For a circuit design, the inventive arrangements are capable of generating constraints for local clock nets in reference to clock pins of a circuit design that are driven by local clocks. These constraints, once generated, may be used by implementation tools to route the local clock nets. As defined within this disclosure, the term “local clock” refers to a signal provided to a clock pin of one or more circuit components of a circuit design, where that signal is generated or processed by circuitry other than the dedicated clock network circuitry of the IC. For example, a local clock is a signal that may originate or pass through a flip-flop or combinatorial circuitry such as a lookup table that is not part of the clock network circuitry reserved for use by global clock signals, but rather is available to implement user-specified circuitry (e.g., data and/or control signals) of a user circuit design. The term “local clock net” refers to the connections between a driver of a local clock and the respective clock pins driven by that local clock. A clock pin of a local clock net also may be referred to as a “local clock pin.”

In one or more examples, for a given circuit design, a system is capable of determining a plurality of delay ranges for respective clock pins of a local clock net. The system may allocate upper bound values of the plurality of delay ranges as setup constraints for respective clock pins of the local clock net. The system also may allocate the lower bound values of the plurality of delay ranges as hold constraints for respective clock pins of the local clock net. The system is capable of routing the local clock net using the setup constraints and the hold constraints.

In one or more examples, the plurality of delay ranges may be determined by creating, using the system, a linear programming formulation of a delay budget problem for the circuit design. A delay budget is a defined range of acceptable delay values for one or more signals and, in the examples described herein, for one or more local clocks and/or local clock nets. The linear programming formulation includes a plurality of variables and a plurality of expressions defining relationships between the plurality of variables. The linear programming formulation may include, as part of the plurality of expressions, a selected expression that maximizes the delay range for each local clock pin. The system may solve the linear programming formulation using a linear programming solver. For example, the system may execute the linear programming solver to generate a solution for the linear programming formulation.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

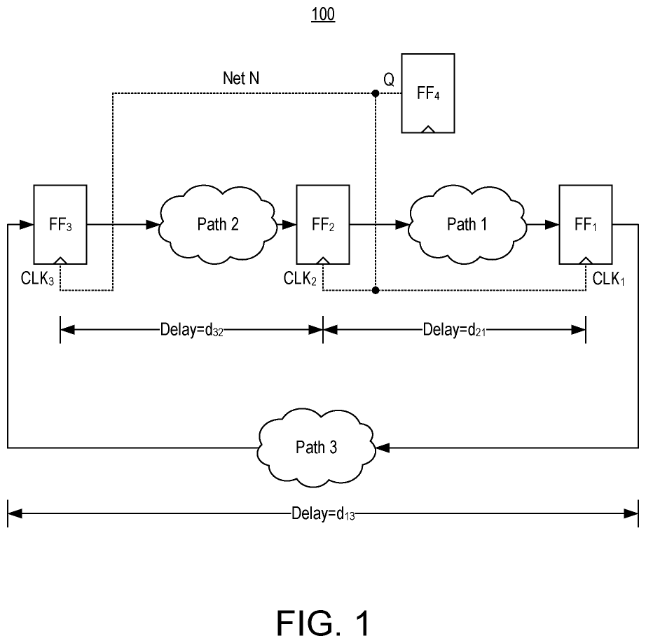

FIG. 1 illustrates an example circuit design 100 including a local clock net. Circuit design 100 may be part of a larger circuit design that also includes clock signals (e.g., global clock nets) conveyed over clock network circuitry (not shown). In the example, circuit design 100 includes a plurality of flip-flops FF₁, FF₂, FF₃, and FF₄. A net N is used to convey a local clock from the Q output of FF₄. As illustrated, the local clock, as conveyed from the Q output of FF₄, is conveyed over non-clock network circuitry and drives the local clock pins CLK₁, CLK₂, and CLK₃ of each of FF₁, FF₂, and FF₃, respectively, forming the local clock net. In the example, the delay for path 1 from the output of FF₂ to the input of FF₁ is illustrated as d₂₁. The delay for path 2 from the output of FF₃ to the input of FF₂ is illustrated as d₃₂. The delay for path 3 from the output of FF₁ to the input of FF₃ is illustrated as d₁₃. In the example, each of paths 1, 2, and 3 may represent or include combinatorial circuitry.

For purposes of illustration, referring to the signal path between FF₁ and FF₃ through the combinatorial circuitry of path 3, T_{clk1} represents the delay for the local clock to reach local clock pin CLK₁ of FF₁ and Talks represents the delay for the local clock to reach local clock pin CLK₃ of FF₃. T represents the timing requirement of the path. Tₛₑₜᵤₚ and T_{hold} are the setup time and hold time, respectively, of the capturing flip-flop FF₃. Expressions 1A, 1B, and 1C below, collectively referred to as “Expression 1,” illustrate the impact of clock skew on setup requirements and hold requirements.

$${T}_{clk 1} + {d}_{13} \leq T + {T}_{clk 3} - {T}_{setup} \qquad ( 1 A )$$

$${d}_{13} \leq T - ( {T}_{clk 1} - {T}_{clk 3} ) - {T}_{setup} \qquad ( 1 B )$$

$${d}_{13} \geq ( {T}_{clk 3} - {T}_{clk 1} ) + {T}_{hold} \qquad ( 1 C )$$

Expression 1B illustrates that the effective requirement of the data path for setup is reduced by (T_{clk1}−T_{clk3}), which makes meeting setup timing requirements more difficult with high clock skew. Expression 1C illustrates that hold time requirements are increased by (T_{clk3}−T_{clk1}). Thus, there is both a setup time and hold time impact that arises due to clock skews. This illustrates the importance of designing low-skew clocks in circuit designs, whether for ICs having fixed clock network circuitry such as Field Programmable Gate Arrays (FPGAs) or for Application Specific ICs (ASICs).

The inventive arrangements are capable of generating a local clock solution having a bounded skew. The examples provided within this disclosure address not only the delay difference reaching different clock pins, but also minimum-maximum (min-max) delay spread of the clock pins to achieve a balance between skew predictability and design closure of signal nets. The inventive arrangements may be used for circuit designs implemented in programmable ICs including FPGAs and/or ASICS.

FIG. 1 illustrates one example of a local clock. It should be appreciated that the local clock conveyed over the local clock net referred to as “net N” may traverse other non-clock network circuit components such as additional flip-flops, lookup-tables, and/or the like. In this regard, FIG. 1 is provided for purposes of illustration and not limitation.

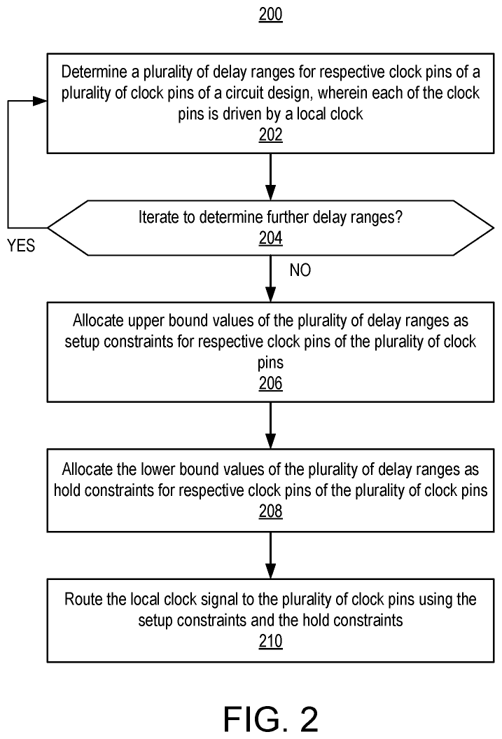

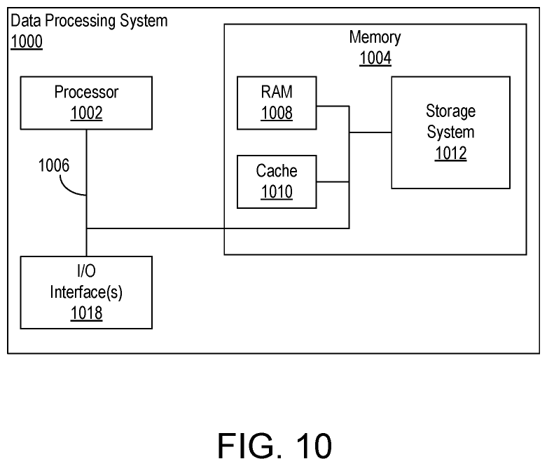

FIG. 2 illustrates an example method 200 of low-skew local clock implementation for a circuit design. The operations described in connection with FIG. 2 may be performed by a data processing system executing suitable program code described herein below in greater detail. An example of a data processing system that is capable of performing the operations described within this disclosure, including those of FIG. 2, is described in connection with FIG. 10.

In block 202, the system determines a plurality of delay ranges for respective clock pins of a local clock net of a circuit design. Each of the clock pins is driven by a local clock. Each delay range includes, or is defined by, an upper bound delay and a lower bound delay.

In one or more example implementations, the system determines the plurality of delay ranges by creating a linear programming formulation of a delay budget problem for the circuit design. The delay budget problem is for determining delay ranges for clock pins of the local clock net of the circuit design. The linear programming formulation, as generated by the system, includes a plurality of variables and a plurality of expressions defining relationships between the plurality of variables. The plurality of delay ranges can be determined by solving the linear programming formulation using a linear programming solver. The linear programming solver may be executed by the system.

In one or more examples, the linear programming formulation includes a selected expression that maximizes the delay range for each clock pin of the local clock net. The plurality of delay ranges may be determined for a set of one or more skew values.

In block 204, the system optionally iterates to determine further delay ranges. For example, the system may perform a plurality of iterations of the determining operation (i.e., determining the plurality of delay ranges for the respective clock pins of the local clock net), such that each iteration of the plurality of iterations is for a different set of one or more skews. In one aspect, the different set of skew(s) used for each iteration may be selected or determined based on a binary search technique. Accordingly, the allocating the upper bound delays, the allocating the lower bound delays (which may include the computing the lower bound delays), and the routing described below in blocks 206, 208, and 210, respectively are performed for a selected plurality of delay ranges from a selected iteration of the plurality of iterations.

In block 206, the system allocates the upper bound delays of the plurality of delay ranges as setup constraints for respective clock pins of the local clock net.

In block 208, the system is capable of allocating the lower bound delays of the plurality of delay ranges as hold constraints for respective clock pins of the local clock net. For example, the system is capable of computing the lower bound delays of the plurality of delay ranges for respective clock pins of the local clock net. The lower bound delays may be computed using scaling factors that are applied to the upper bound delays to generate the lower bound delays.

In block 210, the system is capable of routing the local clock net using the setup constraints and the hold constraints.

In one or more example implementations, the routing may be performed by, at least in part, the system clustering loads of the local clock using a proximity-based clustering technique. For each cluster, the system is capable of driving each local clock pin (e.g., load) of the cluster using a same buffer. Within this disclosure, the term “buffer” may refer to a “routing multiplexer” in the case where a circuit design is to be implemented in a programmable IC such as an FPGA. In the case where a circuit design is to be implemented in an IC such as an ASIC, the term “buffer” may refer to a “clock buffer” and/or a “clock re-buffer.”

In another aspect, for a selected cluster of the plurality of clusters having a plurality of sub-clusters therein, the system is capable of implementing a spiral search from a centroid of the plurality of sub-clusters for an unused buffer. The system routes a driver of the local clock net to the unused buffer and routes the unused buffer of the local clock net to the buffer of each cluster.

The system is capable of generating a linear programming formulation of the delay budget problem for the circuit design as discussed in greater detail below. The example of FIG. 1 illustrates how clock skew can affect the timing, i.e., setup and hold times, of signal paths of a circuit design. Clock skew also may affect timing corners. Typically, for a circuit design, there are multiple timing corners corresponding to different process-voltage-temperature (PVT) conditions. The implementation tools (e.g., the system) must close timing for each such modeled corner.

For example, in the case of FPGAs, there are two dominant corners often modeled. These are slow and fast, which capture extreme conditions resulting in slowest and fastest delays, respectively, of various signal paths of the circuit design. In addition, within each corner, there may be a spread or range of possible delays modeled as the maximum (max) delay and the minimum (min) delay that is able to account for even more sources of variation for each given corner. The inventive arrangements described within this disclosure may be used to implement circuit designs despite the particular number of timing corners modeled and/or the particular number of different delays within each corner modeled by the system.

For purposes of describing the linear programming formulation that is generated in accordance with the inventive arrangements, it is useful to introduce certain terms and notation.

dᵢⱼ^{corner}ₘₐₓ is the maximum delay of the path between FF i and FF j in the corner specified.

dᵢⱼ^{corner}ₘᵢₙ is the minimum delay of the path between FFᵢ and FFⱼ in the corner specified.

d_{clki}^{corner}ₘₐₓ is the maximum delay to clock pinᵢ of the local clock net N in the corner specified.

d_{clki}^{corner}ₘᵢₙ is the minimum delay to clock pinᵢ of the local clock net N in the corner specified.

Within this disclosure, for ease of illustration, it may be assumed that the intrinsic setup times and hold times of the FFs involved are 0. Thus, Tₛₑₜᵤₚ and T_{hold} from Expression 1 is 0. This assumption simplifies the explanation provided within this disclosure but is not intended as a limitation as non-zero values of Tₛₑₜᵤₚ and T_{hold} may be accommodated by the inventive arrangements described within this disclosure.

Given the foregoing discussion, additional expressions may be defined that govern the setup times and the hold times of the example circuit illustrated in FIG. 1. Expressions 2A, 2B, and 2C below, collectively referred to as “Expression 2,” define setup timing.

$${d}_{clk {3}_{max}}^{Corner} + {d}_{{32}_{max}}^{Corner} - {d}_{clk {2}_{min}}^{Corner} \leq T \qquad ( 2 A )$$

$${d}_{clk {2}_{max}}^{Corner} + {d}_{{21}_{max}}^{Corner} - {d}_{clk {1}_{min}}^{Corner} \leq T \qquad ( 2 B )$$

$${d}_{clk {1}_{max}}^{Corner} + {d}_{{13}_{max}}^{Corner} - {d}_{clk {3}_{min}}^{Corner} \leq T \qquad ( 2 C )$$

Expressions 3A, 3B, and 3C below, collectively referred to as “Expression 3,” define hold timing.

$${d}_{clk {3}_{min}}^{Corner} + {d}_{{32}_{min}}^{Corner} - {d}_{clk {2}_{max}}^{Corner} \geq 0 \qquad ( 3 A )$$

$${d}_{clk {2}_{min}}^{Corner} + {d}_{{21}_{min}}^{Corner} - {d}_{clk {1}_{max}}^{Corner} \geq 0 \qquad ( 3 B )$$

$${d}_{clk {1}_{min}}^{Corner} + {d}_{{13}_{min}}^{Corner} - {d}_{clk {3}_{max}}^{Corner} \geq 0 \qquad ( 3 C )$$

Referring to Expression 2 defining setup timing, it may be observed that Expression 2A is easier to satisfy when the d_{clk3} term is lower and the d_{clk2} term is higher. Expression 2B is easier to satisfy, however, if the d_{clk2} term is lower. This condition is illustrative of the conflicting requirements for the values of the clock delay terms. The ideal case is having a difference in clock delays as close to zero as possible. Based on these observations, it can be seen that for the most general use-case, having a zero value clock skew is ideal. In practice, this is not always possible. In accordance with the inventive arrangements, in the absence of achieving a zero clock skew, the linear programming formulation generates a bounded skew clock solution. The system is capable of generating delay budgets for clock pins of local clock nets that result in this bounded skew solution. The bounded skew solution provides for predictable timing of signal paths of the circuit design.

In generating a bounded-skew solution for the local clock nets of a circuit design, the system generates delay budgets for the local clock pins. For each local clock pin, clkᵢ, this involves generating an upper bound delay denoted as Delayᵤₚₚₑᵣ bound and a lower bound delay denoted as Delay_{lower} bound. Expressions 4A and 4B, collectively referred to as “Expression 4,” define delay budgets for local clock pins.

$${d}_{{clki}_{min}}^{Fast} \geq {Delay}_{lower bound} \qquad ( 4 A )$$

$${d}_{{clki}_{max}}^{Slow} \leq {Delay}_{upper bound} \qquad ( 4 B )$$

Existing budgeting techniques seek to distribute available slack on a timing path to various nets on the path. Typically, however, clock pins, unlike data pins, do not have timing slack that may be distributed. Further, existing budgeting techniques, when used, do not directly optimize and/or influence clock skew or imbalances between delays of different pins of a given net. In accordance with the inventive arrangements described within this disclosure, a budgeting technique is provided that is operative for clock nets even in cases where the clock pins do not have any timing slack to distribute. In one or more examples, the system is capable of addressing imbalances between delays of different clock pins of a clock net as a first order objective.

In one or more examples, the linear programming formulation includes clock skew (S). Clock skew is defined as the difference between maximum and minimum clock delays between any pair of FFs(i,j) for a given corner. Expression 5 defines clock skew S within the linear programming formulation.

$${Max}_{i = 1 … n} ( {d}_{{clki}_{max}}^{Corner} ) - {Min}_{i = 1 … n} ( {d}_{{clki}_{min}}^{Corner} ) = S \qquad ( 5 )$$

The maximum and minimum delays to a FF(d_{clki}) in various corners are not independent of each other. The maximum and minimum delays are related to each other through technology node/process scaling parameters given through, or obtainable from, the speed file for the particular technology library being used. The relationship between the minimum and maximum delays for a given corner may be specified by scaling factors used for the different corners. Expressions 6A, 6B, and 6C, collectively referred to as “Expression 6,” define delay scaling factors (μ) for different corners.

$${d}_{{clki}_{min}}^{Slow} = {μ}_{{Slow}_{min}} * {d}_{{clki}_{max}}^{Slow} \qquad ( 6 A )$$

$${d}_{{clki}_{min}}^{Fast} = {μ}_{{Fast}_{min}} * {d}_{{clki}_{max}}^{Slow} \qquad ( 6 B )$$

$${d}_{{clki}_{max}}^{Fast} = {μ}_{{Fast}_{max}} * {d}_{{clki}_{max}}^{Slow} \qquad ( 6 C )$$

The system is capable of using the scaling factors (μ) to translate all delay variables to refer to only d_{clki}_{ₘₐₓ}^{Slow}, Using the scaling factors allows the system to solve the linear programming formulation for only one variable for each FFᵢ. The system obtains the other delay variables using the scaling factors and Expression 6.

In modeling the budgeting problem as a linear programming formulation, the system solves for the values of d_{clkimax}^{Slow}. To generate the upper and lower bound for the delay budgets specified in Expression 4, the system computes a range of delays for each d_{clkimax}^{Slow} variable. For each d_{clkimax}^{Slow} variable, the system uses two variables: ^{Upper}d_{clkimax}^{Slow} and ^{Lower}d_{clkimax}^{Slow}. Both of the ^{Upper}d_{clkimax}^{Slow} and ^{Lower}d_{clkimax}^{Slow} variables must satisfy the constraints of the linear programming formulation, which ensures that every delay value in the respective range(s) will automatically satisfy all necessary constraints.

Within the linear programming formulation, the delay range of a clock variable (Rᵢ) is defined as the difference between the upper and lower bound variables for a given FF. Expression 7 defines the delay range Rᵢ.

$${R}_{i} = {}^{Upper} {d}_{clkimax}^{Slow} - {}^{Lower} {d}_{clkimax}^{Slow} \qquad ( 7 )$$

In one aspect, an objective of the delay budgeting problem modeled as the linear programming formulation is that the delay range for each clock variable is to be maximized. Maximizing the delay range ensures a sufficiently wide enough interval when routing local clock pins so that if the delay achieved is within the interval, the bounded clock skew is guaranteed to be achieved. In cases where the delay range is small, precisely achieving the required delays for the local clock pins becomes difficult particularly since the local clock nets are routed using the non-clock network circuitry (e.g., data signal interconnects) of the IC. In certain ICs such as FPGAs, for example, delays may jump in discrete amounts due to the use of prefabricated routing wires. In such cases, having a relatively large delay increases the likelihood that the routing of the local clock nets will succeed using the determining timing constraints from solving the linear programming formulation.

Maximizing the delay range R may be achieved by including Expressions 8A, 8B, and 8C, collectively referred to as “Expression 8,” within the linear programming formulation.

$$Maximize R \qquad ( 8 A )$$

$$For every clock pin i , \\ {R}_{i} = {}^{Upper} {d}_{clkimax}^{Slow} - {}^{Lower} {d}_{clkimax}^{Slow} For every clock pin i , R \leq {R}_{i} \qquad ( 8 B )$$

$$For every clock pin i , \\ {R}_{i} = {}^{Upper} {d}_{clkimax}^{Slow} - {}^{Lower} {d}_{clkimax}^{Slow} For every clock pin i , R \leq {R}_{i} \qquad ( 8 C )$$

Because the linear programing formulation seeks to maximize the delay range as a primary objective, to achieve the desired bounded clock skew, clock skew as a constant is introduced into the linear programing formulation. To achieve a fixed clock skew S, skew bound inequalities are included in the linear programing formulation as Expressions 9A, 9B, and 9C, collectively referred to as “Expression 9.”

$$For every pair i , j of clock pins , {}^{Upper} {d}_{clkimax}^{Slow} - {μ}_{slow min} * {}^{Lower} {d}_{clkjmax}^{Slow} \leq {S}_{{μ}_{fast max}} * {}^{Upper} {d}_{clkimax}^{Slow} - {μ}_{fast min} * {}^{Lower} {d}_{clkjmax}^{Slow} \leq S \qquad ( 9 A )$$

$$For every pair i , j of clock pins , {}^{Upper} {d}_{clkimax}^{Slow} - {μ}_{slow min} * {}^{Lower} {d}_{clkjmax}^{Slow} \leq {S}_{{μ}_{fast max}} * {}^{Upper} {d}_{clkimax}^{Slow} - {μ}_{fast min} * {}^{Lower} {d}_{clkjmax}^{Slow} \leq S \qquad ( 9 B )$$

$$For every pair i , j of clock pins , {}^{Upper} {d}_{clkimax}^{Slow} - {μ}_{slow min} * {}^{Lower} {d}_{clkjmax}^{Slow} \leq {S}_{{μ}_{fast max}} * {}^{Upper} {d}_{clkimax}^{Slow} - {μ}_{fast min} * {}^{Lower} {d}_{clkjmax}^{Slow} \leq S \qquad ( 9 C )$$

Expression 9 defines constraints on the delay variables to ensure the difference between any pair of clock pins is bounded by S. Expression 9B represents skew in the slow corner. Expression 9C represents skew in the fast corner. For a pair of FFs(i, j), the upper-bound variable for the maximum delay to the local clock pin of FFᵢ and the lower bound variable for the minimum delay to the local clock pin of FFⱼ are used. By using the maximum and minimum delays to specify the skew bound S, so long as the final delay to the local clock pin for an FF per the solution to the linear programming formulation stays within the upper and lower bounds, the clock skew bounds expressed by Expression 9 hold true.

Once the upper and lower bound delays, e.g., the delay ranges, are determined, the system is capable of determining the budget for each clock pin of a local clock net using Expression 4 as illustrated below.

$${d}_{{clki}_{min}}^{Fast} \geq {μ}_{{Fast}_{min}} * {}^{Lower} {d}_{clkimax}^{Slow}$$

$${d}_{{clki}_{max}}^{Slow} \leq {}^{Upper} {d}_{clkimax}^{Slow}$$

In the examples provided within this disclosure, for purposes of illustration, the same value S for both slow and fast corners is used. It should be appreciated that in other examples, different values of S may be used for different timing corners.

The linear programming formulation includes additional constraints that may be used as “sanity checks.” For example, depending on the placement of the driver of the local clock nets and the clock pins of the load FFs, additional constraints on the lower bounds of the delay variables may be used. These additional constraints are illustrated as Expressions 10A, 10B, and 10C, collectively referred to as Expression 10, and are dependent on the shortest paths from the driver to each local clock pin. Expression 10 also may be referred to as “lower bound delay constraints.”

$$For every clock pin i , {}^{Upper} {d}_{clkimax}^{Slow} \geq {D}_{shortest path to i} {}^{Lower} {d}_{clkimax}^{Slow} \geq {D}_{shortest path to i} \qquad ( 10 A )$$

$$For every clock pin i , {}^{Upper} {d}_{clkimax}^{Slow} \geq {D}_{shortest path to i} {}^{Lower} {d}_{clkimax}^{Slow} \geq {D}_{shortest path to i} \qquad ( 10 B )$$

$$For every clock pin i , {}^{Upper} {d}_{clkimax}^{Slow} \geq {D}_{shortest path to i} {}^{Lower} {d}_{clkimax}^{Slow} \geq {D}_{shortest path to i} \qquad ( 10 C )$$

As a sanity check, Expression 10 ensures that the upper delay slow corner for a given local clock pin is not less than the delay of the shortest path to the local clock pin. Expression 10 also ensures that the lower delay slow corner for a given local clock pin is not less than the delay of the shortest path to the local clock pin.

In accordance with the inventive arrangements described herein, the system is capable of generating a routing solution for the local clock nets that fits within the delay range by treating the lower bound delay μ_{fast min}*^{Lower}d_{clkimax}^{Slow} as equivalent to a hold constraint for the local clock pin and treating the upper bound delay ^{Upper}d_{clkimax}^{Slow} as equivalent to a setup constraint for the local clock pin. Accordingly, the system allocates the lower bound delay to the hold constraint for the local clock pin and allocates the lower bound delay to the setup constraint for the local clock pin. These operations allow conventional implementation tools (e.g., regular setup and hold routing engines) to generate the routing solution for the local clock nets where the delay falls within the computed delay range.

Increasing lower bound delays through a hold routing engine can be challenging since standard shortest path finding techniques do not directly work in such cases. To accommodate this reality, additional constraints referred to as “upper bound delay constraints” are added to the linear programming formulation. Expressions 11A, 11B, and 11C, collectively referred to as “Expression 11,” define the upper bound delay constraints. The upper bound delay constraints ensure that the solution determined keeps the lower bound delay of the delay range manageable. In Expression 11, k is an empirically chosen multiplier.

$$For every clock pin i , {}^{Upper} {d}_{clkimax}^{Slow} \leq k * {D}_{shortest path to i} {}^{Lower} {d}_{clkimax}^{Slow} \leq k * {D}_{shortest path to i} \qquad ( 11 A )$$

$$For every clock pin i , {}^{Upper} {d}_{clkimax}^{Slow} \leq k * {D}_{shortest path to i} {}^{Lower} {d}_{clkimax}^{Slow} \leq k * {D}_{shortest path to i} \qquad ( 11 B )$$

$$For every clock pin i , {}^{Upper} {d}_{clkimax}^{Slow} \leq k * {D}_{shortest path to i} {}^{Lower} {d}_{clkimax}^{Slow} \leq k * {D}_{shortest path to i} \qquad ( 11 C )$$

$$For every clock pin i , {}^{Upper} {d}_{clkimax}^{Slow} \leq k * {D}_{shortest path to i} {}^{Lower} {d}_{clkimax}^{Slow} \leq k * {D}_{shortest path to i}$$

The linear programming formulation includes further sanity checks as constraints to ensure that the upper bound delays are greater than the lower bound delays. This is accomplished by adding a non-negative delay range constraint that requires that all delay range variables Rᵢ be non-negative as set forth in Expression 12.

$${R}_{i} \geq 0 \qquad ( 12 )$$

Listing 1 below presents the different variables and expressions described herein that, taken collectively, form a particular linear programming formulation for a given, bounded clock skew S. Solving the linear programming formulation provides upper and lower bound delay budgets for local clock pins to achieve a bounded clock skew of S. The system, for example, is capable of solving linear programming formulations using available linear programming solvers. Examples of linear programming solvers that may be used can include, but are not limited to, the Gurobi Solver Engine, the open-source COIN-OR LP (CLP or Clp) linear programming solver, or other linear programming solver providing similar functionality.

Listing 1

Maximize R
For every clock pin i, Rᵢ = ^{Upper}d_{clkimax}^{Slow} − ^{Lower}d_{clkimax}^{Slow} For every clock pin i, R
≤ Rᵢ
For every pair i, j of clock pins,
^{Upper}d_{clkimax}^{Slow} − μ_{slow min} * ^{Lower}d_{clkjmax}^{Slow} ≤ S
μ_{fast max} * ^{Upper}d_{clkimax}^{Slow} − μ_{fast min} * ^{Lower}d_{clkjmax}^{Slow} ≤ S
For every clock pin i,
^{Upper}d_{clkimax}^{Slow} ≥ D_{shortest path to i}
^{Lower}d_{clkimax}^{Slow} ≥ D_{shortest path to i}
For every clock pin i,
^{Upper}d_{clkimax}^{Slow} ≤ k * D_{shortest path to i}
^{Lower}d_{clkimax}^{Slow} ≤ k * D_{shortest path to i}
k is empirically chosen multiplier
Rᵢ ≥ 0

With reference to Listing 1, the independent variables are the ^{Upper}d_{clkimax}^{Slow} and the ^{Lower}d_{clkimax}^{Slow} variables. The Rᵢ variables are dependent variables computed based on the independent variables. S is a constant value that the solution is attempting to achieve. The D_{shortest path to i} variables are constants that are set based on the placement of the driver and the loads of the local clock net.

In solving the linear programming formulation of Listing 1, the upper and lower bound delays ^{Upper}d_{clkimax}^{Slow} and ^{Lower}d_{clkimax}^{Slow} are obtained. The system treats the upper bound delay as the setup constraint for clock pinᵢ and uses the delay scaling factors to compute the lower bound delays in the fast corner to be used as the hold constraint for clock pinᵢ. An implementation tool that utilizes a conventional setup and hold routing engine may be used to generate a routing solution for the local clock nets, where the delays of the routing solution falls within the obtained delay ranges.

Each linear programming formulation is used to generate a solution for the delay variables given a particular bounded skew S to be achieved. A more optimal skew may be achieved by iteratively performing the linear programming formulation for different bounded skews as discussed in connection with FIG. 2. In one or more example implementations, a binary search technique may be implemented to determine different values of S for iteratively generating and solving different linear programming formulations (e.g., each for a different bounded skew). Using this approach, the system is capable of determining a more optimal tradeoff between the value of S that satisfies all constraints and the range R that is achieved for the value of S. Listing 2 below illustrates a more detailed example of the method of FIG. 2 that may be implemented.

Listing 2

```
S←Sᵢₙᵢₜ
solved←0
while true do
Formulate and solve LP formulation
  if solution Exists then
    solved←1
    if R ≥ R_{Tolerance} then
      if S ≤ S_{Tolerance} then
        Output ^{Upper}D_{clkimax} and ^{Lower}D_{clkimax} ∀i
        break
      else
        Cache current solution
        S←S − δS
        continue
      end if
    else
      S←S + δS
      continue
    end if
  else
    if solved == 1 then
      Output ^{Upper}D_{clkimax} and ^{Lower}D_{clkimax} ∀i
      break
    else
      S←S + δS
      continue
    end if
  end if
end while
```

The inventive arrangements may also employ a routing technique that utilizes a proximity-based clustering approach to cluster local clock pins (e.g., loads) of local clock nets together and assign specific buffers for use in routing the local clock pins of a same cluster. Many modern implementation tools utilize techniques such as Clock Pessimism Removal (CPR) or Clock Reconvergence Pessimism Removal (CRPR) that are capable of evaluating the exact route used by clock nets to more accurately compute skew between any pair of clock pins. The skew computed using these techniques, being more accurate, is often lesser in magnitude than were Expression 5 to be used. Accordingly, the skews may be further improved by optimizing common portions of the routing between pairs of clock pins.

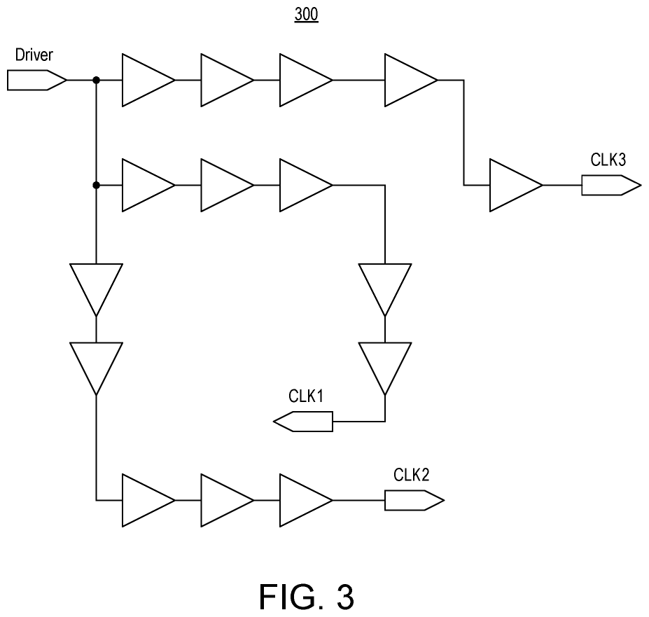

FIG. 3 illustrates an example of a routing topology 300 for a local clock net. In the example, a driver is conveying a clock signal through different paths of the local clock net, each including a plurality of buffers, to three loads corresponding to local clock pins CLK1, CLK2, and CLK3. As can be observed, the local clock signal provided to each of CLK1, CLK2, and CLK3 passes through 5 different buffers. The 5 buffers on each portion of the net are distinct. That is, the set of 5 buffers on the clock signal path from the driver to CLK1 are different from the 5 buffers on the clock signal path from the driver to CLK2. Similarly, the 5 buffers on the clock signal path from the driver to CLK3 are different from the buffers on the clock signal path from the driver to CLK1 and are different from the buffers on the clock signal path from the driver to CLK2.

For purposes of discussion, it may be assumed that each buffer has a delay of dₘₐₓ in the maximum corner and a delay of dₘᵢₙ in the minimum corner. Accordingly, the maximum delay to reach any clock pin is 5*dₘₐₓ. Correspondingly, the minimum delay to reach any clock pin is 5*dₘᵢₙ. The skew S is given by 5*(dₘₐₓ−dₘᵢₙ).

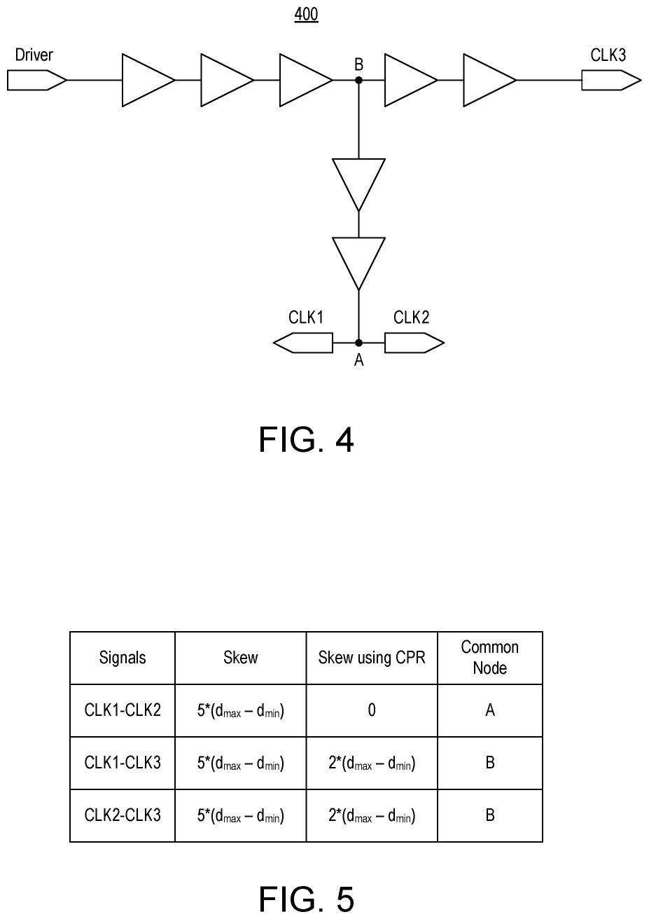

FIG. 4 illustrates an alternative routing topology 400 for the local clock net of FIG. 3. As illustrated in FIG. 4, the clock signal path to each of CLK1, CLK2, and CLK3 shares the first three buffers moving away from the driver. In the example, the clock signal path from the driver to CLK1 and CKL2 has all 5 of the buffers in common. CLK3 differs from CLK1 and from CKL2 only with respect to 2 buffers.

Implementation tools that support CPR recognize that shared buffers between any pair of clock pins do not contribute towards the skew between those clock pins. Such is the case because the contribution of each buffer to account for process variation is determined as dₘₐₓ−dₘᵢₙ. If a given buffer is shared between two clock signal paths (e.g., shared between two clock pins), the delay of that buffer cannot show up on one clock pin as dₘₐₓ and show up for the other clock pin as dₘᵢₙ. Rather, the delay of the shared buffer should be the same when computing delay to both clock pins. The implementation tools utilizing CPR recognize the shared buffers and account for the sharing. Accordingly, with shared buffers, it may be too pessimistic from a timing perspective to consider clock skew between pins as 5*(dₘₐₓ−dₘᵢₙ).

FIG. 5 is a table illustrating the skew between different pairs of clock pins. As illustrated, with CPR being employed by the implementation tools, skew between CLK1 and CLK2 drops to 0 since each clock signal path traverses through the same buffers. For each of CLK1-CLK3 and CLK2-CLK3, the skew drops from 5*(dₘₐₓ−dₘᵢₙ) to 2*(dₘₐₓ−dₘᵢₙ) since 3 of the buffers are shared. By using a proximity-based clustering technique as part of routing the local clocks, the advantages of using shared buffers may be leveraged.

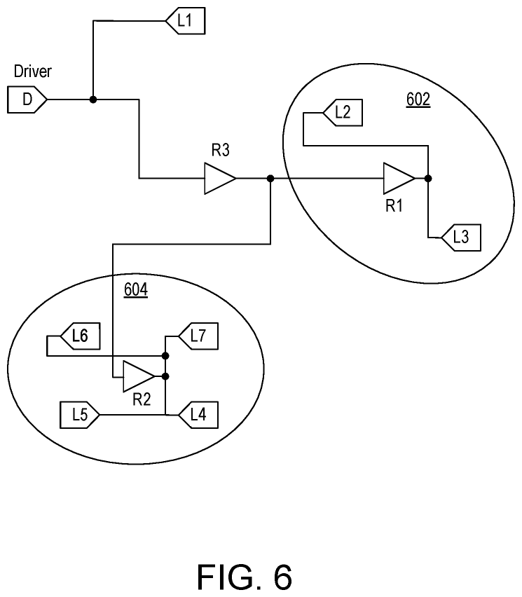

FIG. 6 illustrates a local clock net in which the system has employed proximity-based clustering during routing. The example of FIG. 6 illustrates how the number of common buffers for different clock signal paths of a local clock net may be increased to lower skew. It should be appreciated that the proximity-based clustering techniques described within this disclosure may be utilized in combination with the delay budgeting techniques previously described in connection with FIGS. 1-2 and the linear programming formulation techniques described.

In the example of FIG. 6, a driver D conveys a local clock signal to each of a plurality of loads (e.g., local clock pins) L1, L2, L3, L4, L5, L6, and L7. The local clock signal is conveyed via buffers R3, R2, and R1. The system has clustered loads together and assigned specific buffers that must be used to route to the loads in the same cluster. For example, the system has determined that loads L2 and L3 are within a predetermined distance of one another such that loads L2 and L3 are grouped into a cluster 602. Each load of cluster 602 is driven by a same buffer which is buffer R1 in this example. The system has determined that loads L4, L5, L6, and L7 are within a predetermined distance of one another such that loads L4, L5, L6, and L7 are grouped into a cluster 604. Each load of cluster 604 is driven by a same buffer which is buffer R2 in this example. For loads that are grouped into a same cluster, this technique guarantees that the loads have a common node that is close by to produce smaller skew. In one or more examples, the buffer used for a given cluster may be one that is located at or near a common centroid of the cluster.

In one or more examples, a multi-level clustering approach may be utilized. In the multi-level approach, the buffers that are used to route loads within a cluster themselves become loads for a next level. The technique described to form clusters 602 and 604, for example, may be repeated as necessary to form next level clusters. For example, buffer R3 is common to both clusters 602 and 604. Depending on the circuit design, there are cases where loads belonging to different clusters may not have any common buffer as is the case in FIG. 6 with respect to load L1. In such cases, the bounded skew constraints described in connection with FIGS. 1 and 2 still may be used to obtain an overall skew within specified bounds.

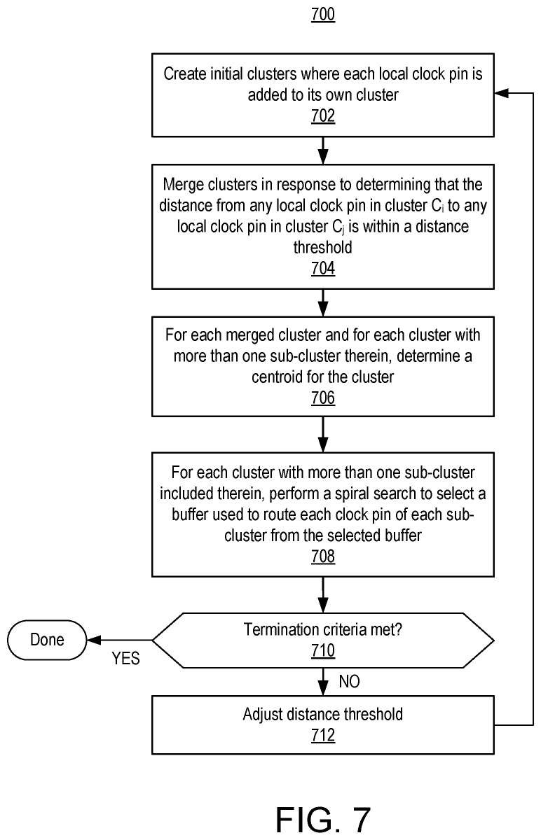

FIG. 7 illustrates an example method 700 of performing the proximity-based clustering described in connection with FIG. 6. Method 700 may be performed by the system as part of the routing operation described in connection with block 210 of FIG. 2.

In block 702, the system creates initial clusters where each local clock pin is added to its own cluster. Accordingly, initially, the number of clusters will equal the number of local clock pins to be routed.

In block 704, the system merges clusters in response to determining that the distance from any local clock pin in a cluster Cᵢ to any local clock pin in a cluster Cⱼ is within a predetermined distance threshold. That is, the system merges two clusters Cᵢ and Cⱼ in response to determining that the distance between any local clock pin in cluster Cᵢ and any local clock pin in cluster Cⱼ is within a distance threshold. Distance may be measured using any of a variety of known distance measurement techniques. In cases where the IC in which the circuit design is to be implemented has a tiled circuit architecture, the distance may be set to a particular number of tiles such as, for example, 5. The operation in block 704 may initially consider each cluster as generated in block 702.

In block 706, for each merged cluster and for each cluster with more than one sub-cluster contained therein, the system determines a centroid of the cluster. For example, once all clusters are considered in block 704, the system is capable of iterating on merged clusters and clusters having more than 1 sub-cluster therein to find the centroid (e.g., coordinates of the centroid) of each such cluster. The system assigns the coordinate of the centroid as the coordinate of the cluster and may be denoted as Pᵢ(Xᵢ, Yᵢ).

In block 708, for each cluster with more than one sub-cluster included therein, the system is capable of performing a spiral search to select a buffer used to route each clock pin of each sub-cluster from the selected buffer. For example, if a cluster has more than one sub-cluster, the system performs a spiral search outward from the centroid of the cluster to locate an unused buffer. In the case of a tiled circuit architecture, the system may perform a spiral search outward from the centroid of the cluster to find an interconnect tile and select an unused buffer within that interconnect tile. The system also may iterate on the unused buffers in the interconnect tile and select a wire type buffer. The system routes each of the sub-clusters in the cluster (e.g., each local clock pin of each sub-cluster of the cluster) from the selected buffer.

In block 710, the system determines whether one or more termination criteria has been met. Examples of a termination criterion may include reaching a particular number of overall clusters (e.g., determining that the number of clusters is less than a predetermined threshold number of clusters) or iterating a particular number of times (exiting after performing a threshold minimum number of iterations). In response to determining that the one or more termination criteria has been met, method 700 may exit. In response to determining that the one or more termination criteria has not been met, method 700 may continue to block 712.

In block 712, the system is capable of adjusting the distance threshold used in block 704. The system increases the distance threshold. As an illustrative and non-limiting example, the distance threshold may be incremented for each iteration. The system may, for example, double the distance threshold for each level of clustering performed. It should be appreciated that other incremental amounts may be used and that the inventive arrangements are not intended to be limited to the particular examples provided. After block 712, method 700 may loop back to block 702 to continue iterating.

Applying the technique illustrated in FIG. 7 to the example of FIG. 6, in the first iteration, the system creates clusters 602 and 604 with assigned buffers R1 and R2, respectively. At the second level (e.g., the second iteration), the system merges clusters 602 and 604 to form a merged cluster to which buffer R3 is assigned. For the merged cluster, the system assigns buffer R3 to route each of sub-clusters 602 and 604 (e.g., clusters 602 and 604 become sub-clusters of the newly formed cluster for purposes of determining or selecting buffer R3). Subsequent to routing sub-clusters 602 and 604 with buffer R3, method 700 ends. The system routes the local clock net from the driver to L1, which stands apart from the other loads, routes the driver to buffer R3, routes buffer R3 to each of buffers R1 and R2, routes each clock pin corresponding to L2 and L3 from buffer R1, and routes each clock pin corresponding to L4, L5, L6, and L7 from buffer R2.

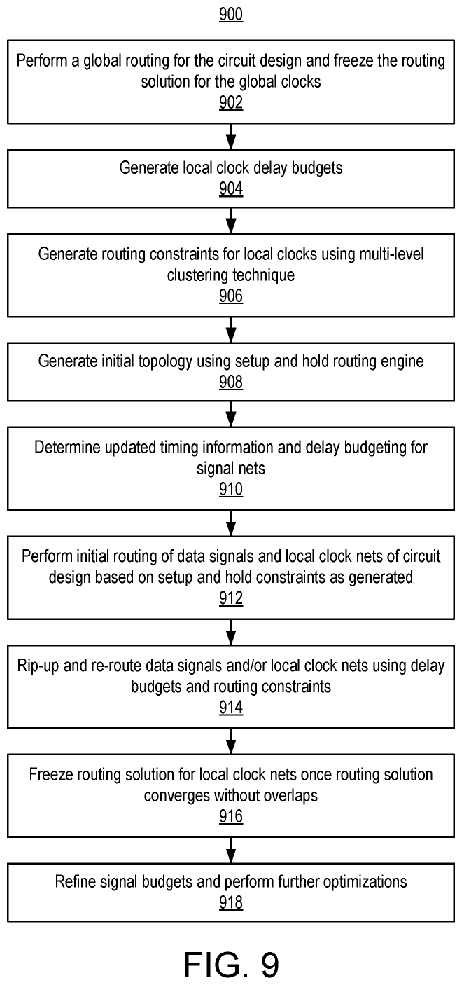

In one aspect, the buffer assignments generated as described may be expressed as further routing constraints that may be provided to conventional implementation tools to route the local clocks in combination with the delay budgets previously described. In addition, the minimum and maximum delay budgets for the local clock pins (e.g., loads), for purposes of routing, may be distributed to the buffers R1, R2, and R3 using any of a variety of known delay budget distribution techniques. For purposes of illustration and not limitation, delay budgeting as described within U.S. Pat. No. 11,238,206 assigned to Xilinx, Inc. may be used. For example, the delay budgeting described in connection with FIG. 9 of U.S. Pat. No. 11,238,206. For example, SLLs as described in U.S. Pat. No. 11,238,206 may be analogized to the buffers described herein. The partitions as described in U.S. Pat. No. 11,238,206 may be analogized to a grouping defined from a buffer R to either other pins (e.g., Ls) or recursively defined buffers in subclusters. Each such group may be considered equivalent to a partition.

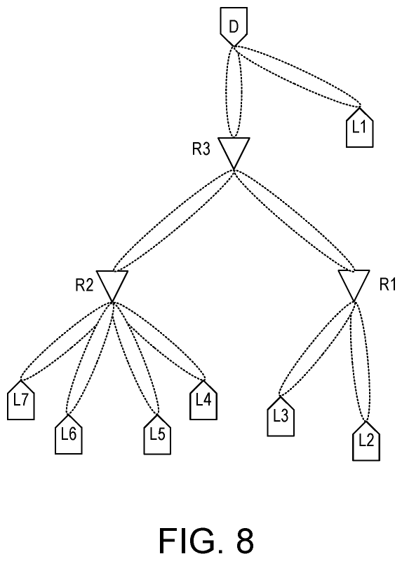

FIG. 8 illustrates another view of the local clock net of FIG. 6. In the example of FIG. 8, the ovals represented with broken/dashed lines indicate the gap or distance on the target IC that may be filled in or connected between two buffers, between a buffer and a load, between the driver and a buffer, and between the driver and a load by a router.

FIG. 9 illustrates another example method 900 for implementing local clocks for a circuit design in accordance with the inventive arrangements described within this disclosure. Method 900 may be performed by a data processing system as described in connection with FIG. 10.

In block 902, the system is capable of performing a global routing for the circuit design and freezing the routing solution for the global clocks. The global routing may route global clock signals, which are clock signals that are routed using the dedicated clock network circuitry of the particular IC in which the circuit design is to be implemented.

In block 904, the system generates the local clock delay budgets as described within this disclosure in connection with FIG. 2, for example. In block 906, the system generates routing constraints for the local clocks using a multi-level clustering technique as described in connection with FIG. 7.

In block 908, the system uses a setup and hold routing engine of the implementation tool(s), e.g., a pathfinder style routing engine, to generate an initial topology (e.g., routing solution) for the local clocks. The setup and hold routing engine uses setup and hold budgets as costs and runs a modified shortest path finder algorithm to generate routing topologies. This is the same for local clocks and for data signals. Local clocks may be handled initially in block 908 because the skews directly affect setup/hold budgets of data signals and there is an implicit order there.

In block 910, the system is capable of performing a timing analysis to determine updated timing information and delay budgeting for signal (e.g., data) nets. The setup/hold budgets for data nets are computed in block 910 based on the initial local clock topology generated in block 908.

In block 912, the system is capable of performing an initial routing of the circuit design (e.g., the data signals) based on the setup and hold constraints generated in block 910. In block 914, the system optionally rips-up and re-routes data signals and/or local clock nets using the delay budgets and routing constraints. In block 916, the system freezes the routing solution for the local clock nets once the routing solution for the circuit design converges without overlaps.

In block 918, the system may optionally refine the signal budgets and perform further optimizations as may be required. Any further optimizations may include further re-routing of data signals. Within this disclosure, a “data signal” is a signal provided to a pin of a circuit component other than a clock pin. A data signal may include a signal provided to a control pin of a circuit component.

For purposes of illustration and explanation, in block 914, the system seeks to legalize all nets including data nets and local clock nets. Given that in block 914, the system may modify the local clock nets to legalize all nets, the system, in legalizing the nets, may change the skews of data signals. To account for any changed skews, once all nets are legalized, the system freezes the local clock nets in block 916 so that skews of the local clock nets cannot change. The system may continue performing optimization of data signals (e.g., data nets) in block 918 by re-determining budgeting for the data signals and rerouting the data signals based on the re-determined budgeting data.

FIG. 10 illustrates an example implementation of a data processing system 1000. As defined herein, the term “data processing system” means one or more hardware systems configured to process data, each hardware system including at least one processor and memory, wherein the processor is programmed with computer-readable instructions that, upon execution, initiate operations. Data processing system 1000 can include a processor 1002, a memory 1004, and a bus 1006 that couples various system components including memory 1004 to processor 1002.

Processor 1002 may be implemented as one or more processors. In an example, processor 1002 is implemented as a central processing unit (CPU). Processor 1002 may be implemented as one or more circuits, e.g., hardware, capable of carrying out instructions contained in program code. The circuit may be an integrated circuit or embedded in an integrated circuit. Processor 1002 may be implemented using a complex instruction set computer architecture (CISC), a reduced instruction set computer architecture (RISC), a vector processing architecture, or other known architectures. Example processors include, but are not limited to, processors having an x86 type of architecture (IA-32, IA-64, etc.), Power Architecture, ARM processors, and the like.

Bus 1006 represents one or more of any of a variety of communication bus structures. By way of example, and not limitation, bus 1006 may be implemented as a Peripheral Component Interconnect Express (PCIe) bus. Data processing system 1000 typically includes a variety of computer system readable media. Such media may include computer-readable volatile and non-volatile media and computer-readable removable and non-removable media.

Memory 1004 can include computer-readable media in the form of volatile memory, such as random-access memory (RAM) 1008 and/or cache memory 1010. Data processing system 1000 also can include other removable/non-removable, volatile/non-volatile computer storage media. By way of example, storage system 1012 can be provided for reading from and writing to a non-removable, non-volatile magnetic and/or solid-state media (not shown and typically called a “hard drive”), which may be included in storage system 1012. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1006 by one or more data media interfaces. Memory 1004 is an example of at least one computer program product.

Memory 1004 is capable of storing computer-readable program instructions that are executable by processor 1002. For example, the computer-readable program instructions can include an operating system, one or more application programs, other program code, and program data. The computer-readable program instructions, e.g., the applications, may include one or more implementation tools that collectively form an EDA system. Examples of implementation tools may include one or more applications and/or program code capable of implementing a design flow that may include operations such as, for example, synthesis, high-level synthesis, placement, routing, and/or bitstream generation as may be required depending on the type of target IC in which the circuit design is to be implemented.

Processor 1002, in executing the computer-readable program instructions, is capable of performing the various operations described herein that are attributable to a computer. It should be appreciated that data items used, generated, and/or operated upon by data processing system 1000 are functional data structures that impart functionality when employed by data processing system 1000. As defined within this disclosure, the term “data structure” means a physical implementation of a data model's organization of data within a physical memory. As such, a data structure is formed of specific electrical or magnetic structural elements in a memory. A data structure imposes physical organization on the data stored in the memory as used by an application program executed using a processor.

Data processing system 1000 may include one or more Input/Output (I/O) interfaces 1018 communicatively linked to bus 1006. I/O interface(s) 1018 allow data processing system 1000 to communicate with one or more external devices and/or communicate over one or more networks such as a local area network (LAN), a wide area network (WAN), and/or a public network (e.g., the Internet). Examples of I/O interfaces 1018 may include, but are not limited to, network cards, modems, network adapters, hardware controllers, etc. Examples of external devices also may include devices that allow a user to interact with data processing system 1000 (e.g., a display, a keyboard, and/or a pointing device) and/or other devices such as accelerator card.

Data processing system 1000 is only one example implementation. Data processing system 1000 can be practiced as a standalone device (e.g., as a user computing device or a server, as a bare metal server), in a cluster (e.g., two or more interconnected computers), or in a distributed cloud computing environment (e.g., as a cloud computing node) where tasks are performed by remote processing devices that are linked through a communications network. In a distributed cloud computing environment, program modules may be located in both local and remote computer system storage media including memory storage devices.

The example of FIG. 10 is not intended to suggest any limitation as to the scope of use or functionality of example implementations described herein. Data processing system 1000 is an example of computer hardware that is capable of performing the various operations described within this disclosure. In this regard, data processing system 1000 may include fewer components than shown or additional components not illustrated in FIG. 10 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

The circuit design, once processed as described herein (e.g., placed and routed), may be physically implemented or realized within a particular IC, whether by way of manufacturing the IC (e.g., as an ASIC) or by the loading of configuration and/or programming data specifying the circuit design into the IC (e.g., a programmable IC).

The terminology used herein is for the purpose of describing particular embodiments only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of computer-readable storage media. A non-exhaustive list of examples of computer-readable storage media include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a portable compact disc read-only memory (CD-ROM), a digital versatile disk (DVD), a memory stick, a floppy disk, or the like.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the term “responsive to” and similar language as described above, e.g., “if,” “when,” or “upon,” means responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, the terms “individual” and “user” each refer to a human being.

As defined herein, the term “hardware processor” means at least one hardware circuit. The hardware circuit may be configured to carry out instructions contained in program code. The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

A computer program product may include a computer-readable storage medium (or media) having computer-readable program instructions thereon for causing a processor to carry out aspects of the inventive arrangements described herein. Within this disclosure, the term “program code” is used interchangeably with the term “program instructions.” Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer-readable program instructions may include state-setting data. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer-readable program instructions by utilizing state information of the computer-readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer-readable program instructions, e.g., program code.

These computer-readable program instructions may be provided to a processor of a computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the operations specified in the flowchart and/or block diagram block or blocks.

The computer-readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more executable instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
for a circuit design, determining a plurality of delay ranges for respective clock pins of a local clock net;
wherein each delay range of the plurality of delay ranges includes an upper bound delay and a lower bound delay;
allocating the upper bound delays of the plurality of delay ranges as setup constraints for the respective clock pins of the local clock net;
allocating the lower bound delays of the plurality of delay ranges as hold constraints for the respective clock pins of the local clock net; and
routing the local clock net using the setup constraints and the hold constraints.

2. The method of claim 1, wherein the determining the plurality of delay ranges comprises:
creating a linear programming formulation of a delay budget problem for the circuit design, wherein the linear programming formulation includes variables and expressions defining relationships between the variables, and wherein a selected expression maximizes the delay range for each clock pin of the local clock net; and
solving the linear programming formulation using a linear programming solver.

3. The method of claim 1, further comprising:
computing the lower bound delays of the plurality of delay ranges for the respective clock pins of the local clock net using scaling factors for the upper bound delays.

4. The method of claim 1, wherein the plurality of delay ranges are determined for a set of one or more skew values.

5. The method of claim 1, further comprising:
performing a plurality of iterations of the determining the plurality of delay ranges for the respective clock pins of the local clock net, wherein each iteration of the plurality of iterations is for a different set of one or more skews;
wherein the allocating the upper bound delays, the allocating the lower bound delays, and the routing are performed for a selected plurality of delay ranges from a selected iteration of the plurality of iterations.

6. The method of claim 5, wherein the sets of one or more skews for the plurality of iterations are determined based on a binary search technique.

7. The method of claim 1, further comprising:
clustering the clock pins of the local clock net using a proximity-based clustering technique to generate a plurality of clusters; and
for each cluster, driving each clock pin of the cluster using a same buffer.

8. The method of claim 7, further comprising:
for a selected cluster of the plurality of clusters having a plurality of sub-clusters therein, implementing a spiral search from a centroid of the plurality of sub-clusters for an unused buffer;
routing a driver of the local clock net to the unused buffer; and
routing the unused buffer of the local clock net to the buffer of each cluster.

9. A system, comprising:
one or more hardware processors configured to initiate operations including:
for a circuit design, determining a plurality of delay ranges for respective clock pins of a local clock net;
wherein each delay range of the plurality of delay ranges includes an upper bound delay and a lower bound delay;
allocating the upper bound delays of the plurality of delay ranges as setup constraints for the respective clock pins of the local clock net;
allocating the lower bound delays of the plurality of delay ranges as hold constraints for the respective clock pins of the local clock net; and
routing the local clock net using the setup constraints and the hold constraints.

10. The system of claim 9, wherein the determining the plurality of delay ranges comprises:
creating a linear programming formulation of a delay budget problem for the circuit design, wherein the linear programming formulation includes variables and expressions defining relationships between the variables, and wherein a selected expression maximizes the delay range for each clock pin of the local clock net; and
solving the linear programming formulation using a linear programming solver.

11. The system of claim 10, wherein the one or more hardware processors are configured to initiate operations further comprising:
computing the lower bound delays of the plurality of delay ranges for the respective clock pins of the local clock net using scaling factors for the upper bound delays.

12. The system of claim 9, wherein the plurality of delay ranges are determined for a set of one or more skew values.

13. The system of claim 9, wherein the one or more hardware processors are configured to initiate operations further comprising:
performing a plurality of iterations of the determining the plurality of delay ranges for the respective clock pins of the local clock net, wherein each iteration of the plurality of iterations is for a different set of one or more skews;
wherein the allocating the upper bound delays, the allocating the lower bound delays, and the routing are performed for a selected plurality of delay ranges from a selected iteration of the plurality of iterations.

14. The system of claim 13, wherein the sets of one or more skews for the plurality of iterations are determined based on a binary search technique.

15. The system of claim 13, wherein the one or more hardware processors are configured to initiate operations further comprising:
clustering the clock pins of the local clock net using a proximity-based clustering technique to generate a plurality of clusters; and
for each cluster, driving each clock pin of the cluster using a same buffer.

16. The system of claim 15, wherein the one or more hardware processors are configured to initiate operations further comprising:
for a selected cluster of the plurality of clusters having a plurality of sub-clusters therein, implementing a spiral search from a centroid of the plurality of sub-clusters for an unused buffer;
routing a driver of the local clock net to the unused buffer; and
routing the unused buffer of the local clock net to the buffer of each cluster.

17. A computer program product comprising one or more computer readable storage mediums having program instructions embodied therewith, wherein the program instructions are executable by computer hardware to cause the computer hardware to initiate executable operations comprising:
for a circuit design, determining a plurality of delay ranges for respective clock pins of a local clock net;
wherein each delay range of the plurality of delay ranges includes an upper bound delay and a lower bound delay;
allocating the upper bound delays of the plurality of delay ranges as setup constraints for the respective clock pins of the local clock net;
allocating the lower bound delays of the plurality of delay ranges as hold constraints for the respective clock pins of the local clock net; and
routing the local clock net using the setup constraints and the hold constraints.

18. The computer program product of claim 17, wherein the determining the plurality of delay ranges comprises:
creating a linear programming formulation of a delay budget problem for the circuit design, wherein the linear programming formulation includes variables and expressions defining relationships between the variables, and wherein a selected expression maximizes the delay range for each clock pin of the local clock net; and
solving the linear programming formulation using a linear programming solver.

19. The computer program product of claim 17, wherein the program instructions are executable by the computer hardware to initiate operations further comprising:
performing a plurality of iterations of the determining the plurality of delay ranges for the respective clock pins of the local clock net, wherein each iteration of the plurality of iterations is for a different set of one or more skews;
wherein the allocating the upper bound delays, the allocating the lower bound delays, and the routing are performed for a selected plurality of delay ranges from a selected iteration of the plurality of iterations.

20. The computer program product of claim 17, wherein the program instructions are executable by the computer hardware to initiate operations further comprising:
clustering the clock pins of the local clock net using a proximity-based clustering technique to generate a plurality of clusters; and
for each cluster, driving each clock pin of the cluster using a same buffer.
